(19) United States
(12) Patent Application Publication
(10) Pub. No.: US 2024/0359692 A1
(43) Pub. Date: Oct. 31, 2024

(54) ILLUMINANCE ESTIMATION DEVICE

(71) Applicant: TOYOTA JIDOSHA KABUSHIKI KAISHA, Toyota-shi (JP)

(72) Inventors: Shiho SATO, Miyoshi-shi (JP); Yasuhiro ISHIKAWA, Okazaki-shi (JP)

(73) Assignee: TOYOTA JIDOSHA KABUSHIKI KAISHA, Toyota-shi (JP)

(21) Appl. No.: 18/641,598

(22) Filed: Apr. 22, 2024

(30) Foreign Application Priority Data
Apr. 25, 2023 (JP) 2023-071227

(51) Int. Cl. B60W 40/06

(52) U.S. Cl. CPC B60W 40/06; B60W 2420/403

(57) ABSTRACT

The illuminance estimation device is a device that estimates illuminance, which is the brightness around the vehicle. The illuminance estimation device acquires a forward image that is an image in front of the vehicle. The illuminance estimation device acquires the brightness of a road surface area, which is an area in which the road surface on which the vehicle travels, is shown in the forward image. The illuminance estimation device determines whether the vehicle will enter a structure into which the vehicle can enter, by analyzing the forward image. The illuminance estimation device obtains a value corresponding to the brightness of the road surface area as the illuminance when it is determined that the vehicle will enter the inside of the structure.

### CROSS-REFERENCE TO RELATED APPLICATION

This application claims priority to Japanese Patent Application No. 2023-071227 filed on Apr. 25, 2023, incorporated herein by reference in its entirety.

### BACKGROUND

### 1. Technical Field

The present disclosure relates to an illuminance estimation device that estimates illuminance that is the lightness around a vehicle based on an image obtained by capturing an area ahead of the vehicle.

### 2. Description of Related Art

Japanese Unexamined Patent Application Publication No. 2005-75304 (JP 2005-75304 A) discloses an example of a control device that automatically turns on lights of a vehicle based on an image obtained by capturing an area ahead of the vehicle with an on-board camera. Specifically, the control device determines whether to automatically turn on the lights based on the brightness of a driving area that is an area where a traveling road of the vehicle is shown in the image and the brightness of a sky area that is an area of the sky associated with the driving area.

A control device that automatically turns on lights by using illuminance estimated based on the above image is considered. The brightness of a sky area that is an area where the sky is shown in the above image is less affected by light sources such as the sun than the brightness of a road surface area that is an area where the road is shown. Therefore, it is preferable that the control device estimate the illuminance based on the brightness of the sky area.

However, there is a possibility that the sky is not shown in the above image when the vehicle enters a structure such as a covered parking lot or a tunnel. In such a case, the control device cannot acquire the brightness of the sky area, which may cause trouble in the estimation of the illuminance.

### SUMMARY

An illuminance estimation device for solving the above problem is configured to estimate illuminance that is lightness around a vehicle.
The illuminance estimation device is configured to:
acquire a forward image that is an image of an area ahead of the vehicle;
acquire brightness of a road surface area that is an area where a road surface on which the vehicle travels is shown in the forward image;
determine whether the vehicle is expected to enter a structure that the vehicle is allowed to enter by analyzing the forward image; and
acquire a value corresponding to the brightness of the road surface area as the illuminance when determination is made that the vehicle is expected to enter the structure.

The illuminance estimation device described above has an effect that the illuminance can be estimated when the vehicle enters the structure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle including an illuminance estimation device and a front camera according to an embodiment;

FIG. 2 is a schematic diagram showing an example of a forward image captured by the front camera of FIG. 1;

FIG. 3 is a schematic diagram showing an example of a forward image captured by the front camera of FIG. 1;

FIG. 4 is a flowchart showing processing executed by the illuminance estimation device of FIG. 1; and

FIG. 5 is a flowchart showing the processing executed by the illuminance estimation device shown in FIG. 1.

### DETAILED DESCRIPTION OF EMBODIMENTS

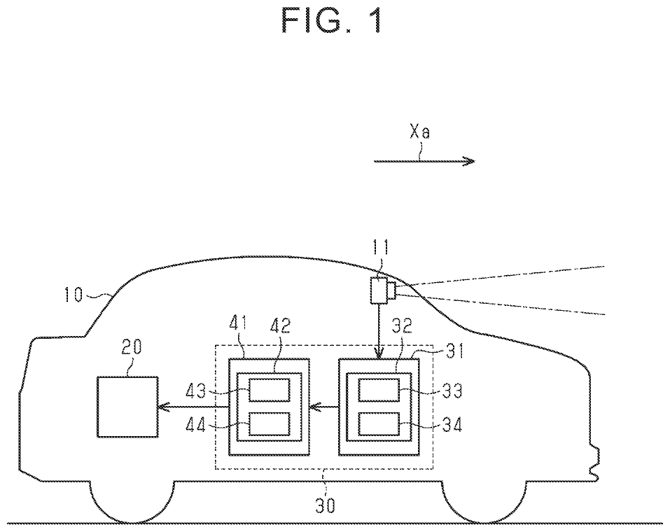

Hereinafter, one embodiment of the illuminance estimation device will be described according to FIGS. 1 to 5.
FIG. 1 illustrates a vehicle 10 including an illuminance estimation device 30. Vehicle 10 further includes a front camera 11 and a light control device 20. The front camera 11 is installed at the front of the vehicle cabin of the vehicle 10. Therefore, the front camera 11 can capture an image of the area in front of the vehicle Xa from the installation position in the vehicle 10. The image captured by the front camera 11 is referred to as a “forward image IMG.” The front camera 11 sequentially transmits data of the forward image IMG to the illuminance estimation device 30.

The illuminance estimation device 30 estimates the illuminance ILL, which is the brightness around the vehicle 10. The illuminance estimation device 30 includes an image recognition device 31 and an illuminance acquisition device 41. The image recognition device 31 analyzes the forward image IMG indicated by the data received from the front camera 11. The illuminance acquisition device 41 acquires the illuminance ILL based on the analysis result of the forward image IMG by the image recognition device 31.

The light control device 20 determines whether to automatically turn on the lights of the vehicle 10 based on the illuminance ILL estimated by the illuminance estimation device 30. For example, the light control device 20 automatically turns on the light when the illuminance ILL becomes equal to or higher than the illuminance for turning on in a situation where the light is turned off. On the other hand, the light control device 20 automatically turns off the light when the illuminance ILL becomes less than the judgment illuminance for turning off the light while the light is on. In this case, the illuminance that is equal to or lower than the lighting determination illuminance is set as the lighting-off determination illuminance.

### Forward Image

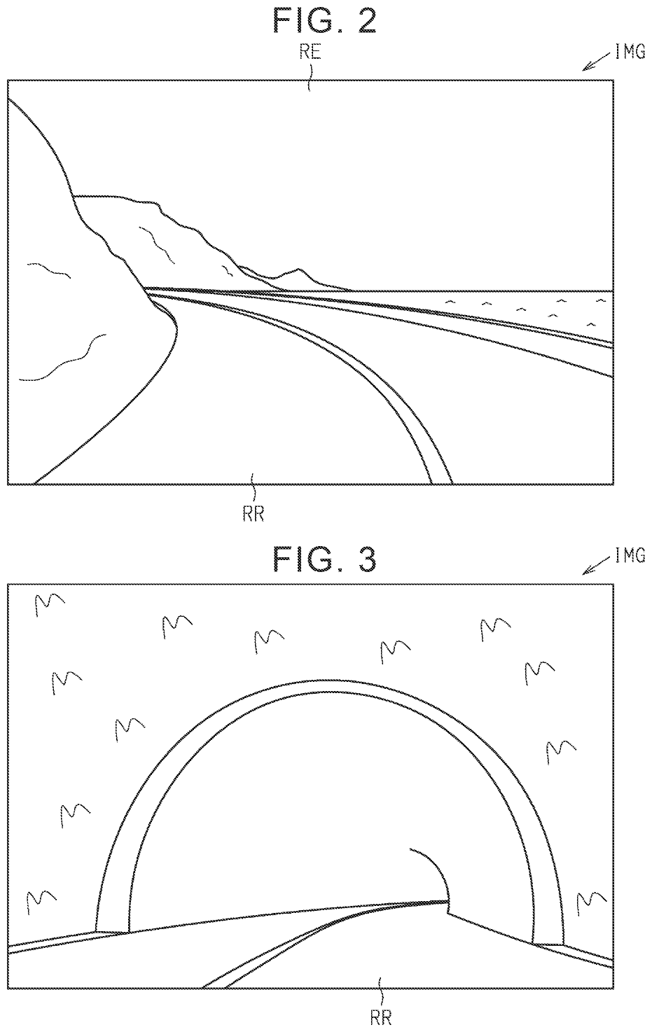

An example of the forward image IMG is illustrated in FIGS. 2 and 3, respectively.
The forward image IMG shown in FIG. 2 shows the road surface on which the vehicle 10 travels and the sky. In the forward image IMG, the area in which the road surface is shown is referred to as a “road surface area RR.” In the forward image IMG, the area in which the sky is reflected is referred to as a “sky area RE.” The forward image IMG shown in FIG. 2 includes both a road surface area RR and a sky area RE.

The forward image IMG shown in FIG. 3 shows a road surface on which the vehicle 10 travels and a tunnel, which is an example of a structure. The forward image IMG represents that the vehicle 10 is just about to enter the inside of the tunnel. The “structure” here is one that is configured such that the vehicle 10 can enter therein. Examples of structures include tunnels and self-propelled covered parking lots. The forward image IMG shown in FIG. 3 includes the road surface area RR, but does not include the sky area RE.

### Image Recognition Device for Illuminance Estimation Device

As shown in FIG. 1, the image recognition device 31 includes a processing circuit 32. An example of the processing circuit 32 is an electronic control device. In this case, the processing circuit 32 includes a CPU 33 and a memory 34. Memory 34 stores a control program executed by CPU 33. When the CPU 33 executes the control program in the memory 34, the processing circuit 32 executes an analysis process for analyzing the forward image IMG. The details of the analysis process will be described later. Illuminance acquisition device for illuminance estimation device

As shown in FIG. 1, the illuminance acquisition device 41 includes a processing circuit 42. An example of the processing circuit 42 is an electronic control unit. In this case, the processing circuit 42 includes a CPU 43 and a memory 44. Memory 44 stores a control program executed by CPU 43. When the CPU 43 executes the control program in the memory 44, the processing circuit 42 executes an illuminance acquisition process to acquire the illuminance ILL. The details of the illuminance acquisition process will be described later.

Note that hereinafter, the processing circuit 32 of the image recognition device 31 will be referred to as the “first processing circuit 32.” The processing circuit 42 of the illuminance acquisition device 41 is referred to as a “second processing circuit 42.”

### Analysis Processing

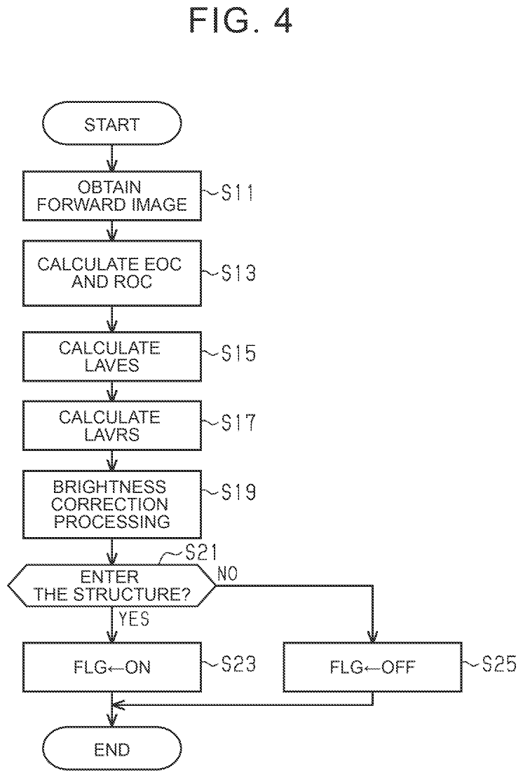

The analysis process executed by the image recognition device 31 will be described with reference to FIG. 4. In the image recognition device 31, the CPU 33 executes the control program in the memory 34, so that the first processing circuit 32 repeatedly executes the analysis process every predetermined control cycle.

In S11, the first processing circuit 32 acquires data of the forward image IMG. In subsequent S13, the first processing circuit 32 calculates the empty space occupancy rate EOC, which is the occupancy rate of the sky area RE, in the currently acquired forward image IMG. The first processing circuit 32 calculates the road surface occupancy rate ROC, which is the occupancy rate of the road surface area RR, of the currently acquired forward image IMG. For example, the first processing circuit 32 uses a known image recognition technique to extract the sky area RE from the forward image IMG, and then calculates the area of the extracted sky area RE. The first processing circuit 32 then calculates the area of the sky area RE with respect to the total area of the forward image IMG as the empty space occupancy rate EOC. Similarly, the first processing circuit 32 uses a known image recognition technique to extract the road surface area RR from the forward image IMG, and then calculates the area of the extracted road surface area RR. The first processing circuit 32 then calculates the area of the road surface area RR relative to the total area of the forward image IMG as the road surface occupancy rate ROC.

In the next S15, the first processing circuit 32 calculates the average brightness LAVES of the sky area RE as the brightness of the sky area RE. For example, the first processing circuit 32 divides the sky area RE of the forward image IMG into a plurality of divided regions. The first processing circuit 32 calculates the brightness of each of the plurality of divided areas. The first processing circuit 32 then calculates the average value of the brightness of the plurality of divided areas as the average brightness LAVES of the sky area RE.

Subsequently, in S17, the first processing circuit 32 calculates the average brightness LAVRS of the road surface area RR as the brightness of the road surface area RR. For example, the first processing circuit 32 divides the road surface area RR of the forward image IMG into a plurality of divided regions. The first processing circuit 32 calculates the brightness of each of the plurality of divided areas. The first processing circuit 32 then calculates the average value of the luminances of the plurality of divided regions as the average luminance LAVRS of the road surface area RR.

Then, in S19, the first processing circuit 32 performs a correction process for the average brightness LAVES and LAVRS calculated in S15 and S17. For example, the first processing circuit 32 corrects the average brightness LAVES and LAVRS based on the current time zone, season, weather, and the like. For example, when the road surface is covered with snow, the average brightness LAVRS of the road surface area RR tends to become high, so the first processing circuit 32 corrects the average brightness LAVRS of the road surface area RR by decreasing it. For example, when the sky is reddish due to sunset, the average luminance LAVES of the sky area RE tends to be high, so the first processing circuit 32 corrects the average luminance LAVES of the sky area RE by decreasing it.

In the next S21, the first processing circuit 32 determines whether the vehicle 10 will enter the inside of a structure by analyzing the forward image IMG. For example, the first processing circuit 32 can determine that the vehicle 10 enters the inside of a structure when the following conditions (A1) and (A2) are satisfied. In this case, the first processing circuit 32 determines that the vehicle 10 will not enter the structure if at least one of the following conditions (A1) and (A2) is not satisfied.

(A1) A structure is shown in the forward image IMG.
(A2) The distance from the vehicle 10 to the structure is less than the determination distance. When the first processing circuit 32 determines that the vehicle 10 will enter the inside of the structure (YES in S21), the process proceeds to S23. On the other hand, when the first processing circuit 32 determines that the vehicle 10 does not enter the inside of the structure (NO in S21), the process proceeds to S25.

In S23, the first processing circuit 32 sets the entry flag FLG to ON. The entry flag FLG is a flag that is set to ON when it is determined that the vehicle 10 will enter the inside of the structure. Thereafter, the first processing circuit 32 temporarily ends the analysis process.

In S25, the first processing circuit 32 sets the entry flag FLG to OFF. Thereafter, the first processing circuit 32 temporarily ends the analysis process.

### Illuminance Acquisition Processing

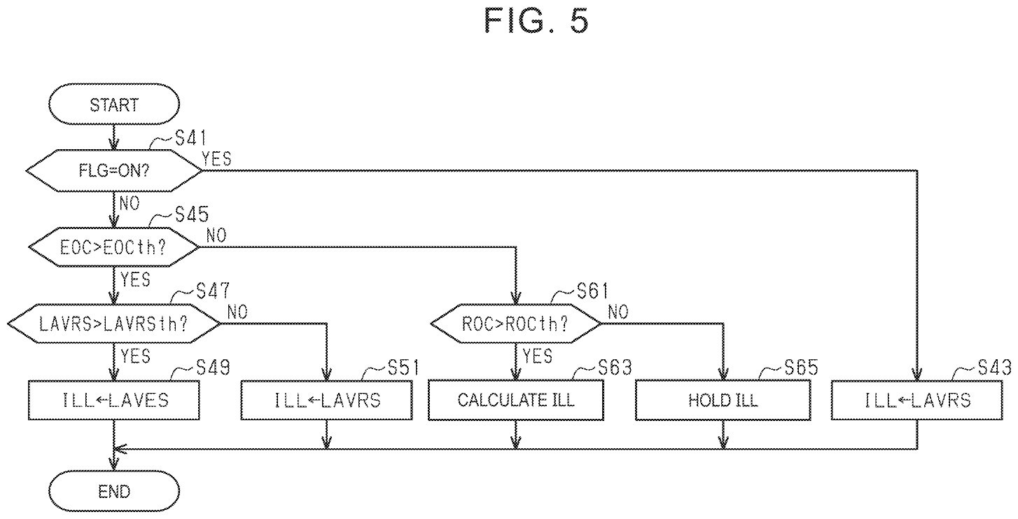

With reference to FIG. 5, the illuminance acquisition process executed by the illuminance acquisition device 41 will be described. In the illuminance acquisition device 41, the CPU 43 executes the control program in the memory 44, so that the second processing circuit 42 repeatedly executes the illuminance acquisition process every predetermined control cycle. In S41, the second processing circuit 42 determines whether the entry flag

FLG is set to on. The case where the entry flag FLG is set to ON means the case where it is determined that the vehicle 10 will enter the inside of the structure. The case where the entry flag FLG is not set to ON means the case where it is determined that the vehicle 10 will not enter the inside of the structure. If the entry flag FLG is set to ON (YES in S41), the second processing circuit 42 shifts the process to S43. On the other hand, if the entry flag FLG is set to OFF (NO in S41), the second processing circuit 42 shifts the process to S45.

In S43, the second processing circuit 42 obtains the average luminance LAVRS of the road surface area RR as the illuminance ILL. That is, when the second processing circuit 42 determines that the vehicle 10 will enter the inside of the structure, the second processing circuit 42 obtains a value corresponding to the brightness of the road surface area RR as the illuminance ILL. Then, the second processing circuit 42 temporarily ends the illuminance acquisition process.

In S45, the second processing circuit 42 determines whether the empty space occupancy rate EOC is higher than the empty space occupancy rate determination value EOCth. It is presumed that the lower the empty space occupancy rate EOC is, the lower the correlation between the brightness of the sky area RE and the actual value of illuminance tends to be. Therefore, the empty space occupancy rate determination value EOCth is set as a criterion for determining whether the correlation between the brightness of the sky area RE and the actual value of illuminance is low. If the empty space occupancy rate EOC is higher than the empty space occupancy rate determination value EOCth (YES in S45), the second processing circuit 42 shifts the process to S47. On the other hand, if the empty space occupancy rate EOC is equal to or less than the empty space occupancy rate determination value EOCth (NO in S45), the second processing circuit 42 shifts the process to S61.

In S47, the second processing circuit 42 determines whether the average brightness LAVRS of the road surface area RR is higher than the road surface brightness determination value LAVRSth. It is presumed that the higher the luminance of the road surface area RR is, the lower the correlation between the luminance of the road surface area RR and the actual value of illuminance tends to be. Therefore, a criterion for determining whether the correlation between the brightness of the sky area RE and the actual value of illuminance is low is set as the road surface brightness determination value LAVRSth. If the average brightness LAVRS of the road surface area RR is higher than the road surface brightness determination value LAVRSth (YES in S47), the second processing circuit 42 shifts the process to S49. On the other hand, if the average brightness LAVRS is equal to or less than the road surface brightness determination value LAVRSth (NO in S47), the second processing circuit 42 shifts the process to S51.

In S49, the second processing circuit 42 obtains the average luminance LAVES of the sky area RE as the illuminance ILL. That is, when determining that the vehicle 10 will not enter the inside of the structure, the second processing circuit 42 determines that the empty space occupancy rate EOC is higher than the empty space occupancy rate determination value EOCth, and that the average brightness of the road surface area LA VRS is higher than the road surface brightness determination value LAVRSth, a value corresponding to the brightness of the sky area RE is acquired as the illuminance ILL. Then, the second processing circuit 42 temporarily ends the illuminance acquisition process.

In S51, the second processing circuit 42 obtains the average luminance LAVRS of the road surface area RR as the illuminance ILL. That is, when determining that the vehicle 10 will not enter the inside of the structure, the second processing circuit 42 determines that the empty space occupancy rate EOC is higher than the empty space occupancy rate determination value EOCth, and that the average brightness of the road surface area LAVRS is less than or equal to the road surface brightness determination value LAVRSth, a value corresponding to the brightness of the road surface area RR is acquired as the illuminance ILL. Then, the second processing circuit 42 temporarily ends the illuminance acquisition process.

In S61, the second processing circuit 42 determines whether the road surface occupancy rate ROC is higher than the road surface occupancy rate determination value ROCth. It is presumed that the lower the road surface occupancy rate ROC is, the lower the correlation between the luminance of the road surface area RR and the actual value of illuminance tends to be. Therefore, a road surface occupancy rate determination value ROCth is set as a criterion for determining whether the correlation between the brightness of the road surface area RR and the actual value of illuminance is low. If the road surface occupancy rate ROC is higher than the road surface occupancy rate determination value ROCth (YES in S61), the second processing circuit 42 shifts the process to S63. On the other hand, if the road surface occupancy rate ROC is less than or equal to the road surface occupancy rate determination value ROCth (NO in S61), the second processing circuit 42 shifts the process to S65.

In S63, the second processing circuit 42 calculates the illuminance ILL based on the last sky average brightness LAVESL, the last road surface average brightness LAVRSL, and the average brightness LA VRS of the road surface area RR. Specifically, the second processing circuit 42 calculates the illuminance ILL using the following relational expression (D1). Note that the last sky average luminance LAVESL is the average luminance LAVES of the sky area RE at the time when the state is switched from a state in which at least one of the determinations in S45 and S61 is negative (NO) to a state in which both determinations are positive (YES). The last road surface average luminance LAVRSL is the average luminance LA VRS of the road surface area RR at the time when the state is switched from a state in which at least one of the determinations in S45 and S61 is negative (NO) to a state in which both determinations are positive (YES).

$$ILL = LAVESL \times LAVES \div LAVRSL \qquad ( D1 )$$

The fact that both the empty space occupancy rate EOC is equal to or less than the empty space occupancy rate determination value EOCth and the road surface occupancy rate ROC is higher than the road surface occupancy rate determination value ROCth is said to be “a predetermined condition is met.” In this case, the brightness of the road surface area at the time when the predetermined condition is satisfied is defined as “predetermined road surface brightness.” The second processing circuit 42 calculates the illuminance ILL such that when the predetermined condition is satisfied, the illuminance ILL increases as the luminance of the current road surface area RR with respect to the predetermined road surface luminance increases. Then, the second processing circuit 42 temporarily terminates the illuminance acquisition device.

In S65, the second processing circuit 42 holds the illuminance ILL. Specifically, the second processing circuit 42 obtains the previous value of the illuminance ILL as the latest value of the illuminance ILL. The previous value of illuminance ILL is the illuminance ILL acquired when the illuminance acquisition process was executed last time. That is, when determining that the vehicle 10 will not enter the inside of the structure, the second processing circuit 42 holds the illuminance ILL when the following both conditions are satisfied: the empty space occupancy rate EOC is equal to or less than the empty space occupancy rate determination value EOCth; and the road surface occupancy rate ROC is equal to or lower than the road surface occupancy rate determination value ROCth. Then, the second processing circuit 42 temporarily ends the illuminance acquisition process.

### Action and Effect

(1) When it is determined that the vehicle 10 will enter the inside of a structure, the illuminance estimation device 30 acquires the average brightness LAVRS of the road surface area RR as the illuminance ILL. That is, the illuminance estimation device 30 can estimate the illuminance ILL without using information regarding the sky area RE, that is, the average brightness LAVES and the empty space occupancy rate EOC of the sky area RE. Therefore, the illuminance estimation device 30 can estimate the illuminance when the vehicle 10 enters the inside of the structure.

(2) In the case where it is determined that the vehicle 10 will enter the inside of a structure, when it can be determined that the empty space occupancy rate EOC in the forward image IMG is relatively high, the illuminance estimation device 30 estimates the illuminance ILL based on the brightness of the sky area RE or the brightness of the road surface area RR.

When the empty space occupancy rate EOC is higher than the empty space occupancy rate determination value EOCth, and the average luminance LAVRS of the road surface area RR is relatively high, it can be estimated that the current time is daytime. During the day, a large amount of light from the sun hits the road surface. Therefore, when the vehicle 10 is running during the daytime, it is estimated that the correlation between the brightness of the road surface area RR and the actual value of illuminance is not very high. Therefore, when the empty space occupancy rate EOC is higher than the empty space occupancy rate determination value EOCth and the average brightness LAVRS of the road surface area RR is higher than the road surface brightness judgment value LAVRSth, the illuminance estimation device 30 calculates the average brightness LAVES of the sky area RE. Obtained as illuminance ILL. That is, the illuminance estimation device 30 estimates the illuminance ILL without using the luminance of the road surface area RR. Thereby, the illuminance estimation device 30 can accurately estimate the illuminance ILL.

On the other hand, when the empty space occupancy rate EOC is higher than the empty space occupancy rate determination value EOCth, and the average luminance LAVRS of the road surface area RR is relatively low, it can be inferred that it is evening or nighttime. In the evening and at night, a large amount of light from light sources such as the sun does not enter the road surface. Therefore, when the vehicle 10 is traveling in the evening or at night, it is estimated that the correlation between the brightness of the road surface area RR and the actual value of illuminance is relatively high. Therefore, when the empty space occupancy rate EOC is higher than the empty space occupancy rate determination value EOCth and the average brightness LAVRS of the road surface area RR is less than or equal to the road surface brightness judgment value LAVRSth, the illuminance estimation device 30 calculates the average brightness LAVRS of the road surface area RR. Obtained as illuminance ILL.

Therefore, the illuminance estimation device 30 can accurately estimate the illuminance ILL regardless of the time zone in which the vehicle 10 is traveling.
(3) When it is determined that the vehicle 10 will enter the inside of a structure, if it can be determined that the empty space occupancy rate EOC in the forward image IMG is relatively low, it can be inferred that the forward image IMG does not show much sky. In this case, if the illuminance ILL is estimated using information regarding the sky area RE, there is a risk that the accuracy will be reduced.

In this regard, if the empty space occupancy rate EOC is less than or equal to the empty space occupancy rate determination value EOCth, and the road surface occupancy rate ROC is higher than the road surface occupancy rate determination value ROCth, the illuminance estimation device 30 uses the above relational expression (D1). to calculate the illuminance ILL. As a result, the illuminance estimation device 30 changes from a state where at least one of the determinations in S45 and S61 is negative (NO) to a state in which both of the two determinations are positive (YES). The illuminance ILL can be estimated based on the rate of change in the average brightness LAVES of the road surface area RR. As a result, the illuminance estimation device 30 can estimate the illuminance ILL even when the empty space occupancy rate EOC is relatively low.

(4) In the case where it is determined that the vehicle 10 will enter the inside of a structure, if it is determined that both the empty space occupancy rate EOC and the road surface occupancy rate ROC in the forward image IMG are relatively low, the brightness of the sky area RE and It can be inferred that both the correlation with the actual value of illuminance and the correlation between the brightness of the road surface area RR and the actual value of illuminance are low. Therefore, the illuminance estimation device 30 maintains the illuminance ILL when the empty space occupancy rate EOC is less than or equal to the empty space occupancy rate determination value EOCth and the road surface occupancy rate ROC is less than or equal to the road surface occupancy rate determination value ROCth. Thereby, the illuminance estimation device 30 can suppress a decrease in the accuracy of estimating the illuminance ILL.

### Modifications

The above embodiment can be implemented with the following modifications. The above embodiment and the following modifications can be combined with each other within a technically consistent range to be implemented.

In the analysis process shown in FIG. 4, the second processing circuit 42 may set the entry flag FLG to ON even if the vehicle 10 has already entered the inside of the structure.
If the empty space occupancy rate EOC is equal to or less than the empty space occupancy rate determination value EOCth (NO in S45), the second processing circuit 42 performs the processing in S63 whether the road surface occupancy rate ROC is higher than the road surface occupancy rate determination value ROCth. The illuminance ILL may be calculated by the process.

When the empty space occupancy rate EOC is equal to or less than the empty space occupancy rate determination value EOCth (NO in S45), the second processing circuit 42 controls the illuminance regardless of whether the road surface occupancy rate ROC is higher than the road surface occupancy rate determination value ROCth ILL may be retained.

When the empty space occupancy rate EOC is higher than the empty space occupancy rate determination value EOCth (YES in S45), the second processing circuit 42 performs a process regardless of whether the average luminance LAVRS of the road surface area RR is higher than the road surface brightness judgment value LAVRSth, the average brightness LAVES of the sky area RE may be acquired as the illuminance ILL.

When the empty space occupancy rate EOC is higher than the empty space occupancy rate determination value EOCth (YES in S45), the second processing circuit 42 performs a process regardless of whether the average luminance LAVRS of the road surface area RR is higher than the road surface brightness judgment value LAVRSth., the average brightness LAVRS of the road surface area RR may be acquired as the illuminance ILL.

In the processes of S43 and S51 in FIG. 5, the second processing circuit 42 acquires a value different from the average brightness LAVRS as the illuminance ILL, if a value corresponding to the brightness of the road surface area RR can be acquired as the illuminance ILL. Good too. For example, the second processing circuit 42 may obtain the brightness of the divided area with the highest brightness in the road surface area RR as the illuminance ILL.

In the process of S49 in FIG. 5, the second processing circuit 42 may obtain a value different from the average brightness LAVES as the illuminance ILL, as long as it can acquire a value corresponding to the brightness of the sky area RE as the illuminance ILL. For example, the second processing circuit 42 may obtain the brightness of the divided area with the highest brightness in the sky area RE as the illuminance ILL.

In the above embodiment, an example is described in which the illuminance ILL estimated by the illuminance estimation device 30 is used for control for automatically turning on and off lights. However, the illuminance ILL can be used for other controls in the vehicle 10. For example, the illuminance ILL may be used to control the dimming of a display inside a vehicle.

The second processing circuit 42 is not limited to one that includes a CPU and a ROM and executes software processing. That is, the second processing circuit 42 may have any of the following configurations (a), (b), and (c).

(a) The second processing circuit 42 includes one or more processors that execute various processes according to computer programs. The processor includes a CPU and memory such as RAM and ROM. The memory stores a program code or an instruction configured to execute the CPU to perform processes. Memory, or computer-readable media, includes any available media that can be accessed by a general purpose or special purpose computer.

(b) The second processing circuit 42 includes one or more dedicated hardware circuits that execute various processes. Dedicated hardware circuits may include, for example, application specific integrated circuits, ie ASICs or FPGAs. Note that ASIC is an abbreviation for “Application Specific Integrated Circuit,” and FPGA is an abbreviation for “Field Programmable Gate Array.”

(c) The second processing circuit 42 includes a processor and a dedicated hardware circuit. The processor executes part of various processes according to a computer program. The hardware circuit executes the remaining processes among the various processes.

The first processing circuit 32 may have any of the configurations (a), (b), and (c) above.
Note that the expression “at least one” used in this specification means “one or more” of the desired options. As an example, the expression “at least one” as used herein means “only one option” or “both of the two options” if the number of options is two. As another example. the expression “at least one” as used herein means “only one option” or “any combination of two or more options” if there are three or more options.

What is claimed is:

1. An illuminance estimation device configured to estimate illuminance that is lightness around a vehicle, wherein the illuminance estimation device is configured to:
acquire a forward image that is an image of an area ahead of the vehicle;
acquire brightness of a road surface area that is an area where a road surface on which the vehicle travels is shown in the forward image;
determine whether the vehicle is expected to enter a structure that the vehicle is allowed to enter by analyzing the forward image; and
acquire a value corresponding to the brightness of the road surface area as the illuminance when determination is made that the vehicle is expected to enter the structure.

2. The illuminance estimation device according to claim 1, wherein the illuminance estimation device is configured to:
acquire an occupancy rate of a sky area that is an area where a sky is shown in the forward image;
acquire brightness of the sky area; and
acquire a value corresponding to the brightness of the sky area as the illuminance when the occupancy rate of the sky area is higher than a sky occupancy rate determination value and the brightness of the road surface area is higher than a road surface brightness determination value in a case where determination is made that the vehicle is expected not to enter the structure.

3. The illuminance estimation device according to claim 2, wherein the illuminance estimation device is configured to acquire the value corresponding to the brightness of the road surface area as the illuminance when the occupancy rate of the sky area is higher than the sky occupancy rate determination value and the brightness of the road surface area is equal to or lower than the road surface brightness determination value in the case where determination is made that the vehicle is expected not to enter the structure.

4. The illuminance estimation device according to claim 1, wherein the illuminance estimation device is configured to:
acquire an occupancy rate of a sky area that is an area where a sky is shown in the forward image;
acquire an occupancy rate of the road surface area in the forward image; and
when the occupancy rate of the sky area is equal to or lower than a sky occupancy rate determination value and the occupancy rate of the road surface area is higher than a road surface occupancy rate determination value in a case where determination is made that the vehicle is expected not to enter the structure, calculate the illuminance to increase the illuminance along with an increase in current brightness of the road surface area compared with brightness of the road surface area at a timing when the occupancy rate of the sky area is equal to or lower than the sky occupancy rate determination value and the occupancy rate of the road surface area is higher than the road surface occupancy rate determination value.

5. The illuminance estimation device according to claim 4, wherein the illuminance estimation device is configured to maintain the illuminance when the occupancy rate of the sky area is equal to or lower than the sky occupancy rate determination value and the occupancy rate of the road surface area is equal to or lower than the road surface occupancy rate determination value in the case where determination is made that the vehicle is expected not to enter the structure.
